(19) United States
(12) Patent Application Publication
(10) Pub. No.: US 2006/0026684 A1
(43) Pub. Date: Feb. 2, 2006

(54) Host intrusion prevention system and method

(75) Inventors: Ralph Harvey, Harrietsham (GB); Darren Harter, Hucclecote (GB); Markus Hartwig, Rostock (DE); Paul Stubbs, Wyboston (GB)

Correspondence Address: PILLSBURY WINTHROP SHAW PITTMAN, LLP, P.O. BOX 10500, MCLEAN, VA, 22102, US

(73) Assignee: Prevx Ltd., Buckinghamshire (GB)

(21) Appl. No.: 11/183,322

(22) Filed: Jul. 18, 2005

Related U.S. Application Data
(60) Provisional application No. 60/589,017, filed on Jul. 20, 2004.

(51) Int. Cl. G06F 12/14

(52) U.S. Cl. 726/23

(57) ABSTRACT

A system and method of host intrusion prevention for preventing intrusion into a computer system is disclosed. Requests to access a resource of the computer system are monitored. It is determined whether the requested access is to be permitted or not in accordance with a policy. The requested access is allowed or denied accordingly.

### 1. RELATED APPLICATIONS

This Application is based on U.S. Provisional Application No. 60/589,017 filed Jul. 20, 2004, the entire contents of which are hereby incorporated by reference.

### 2. BACKGROUND

The present invention relates to a host intrusion prevention system and method.

Malicious software (sometimes known as “malware”) may be distributed via a variety of mechanisms, including email, file transfer, web browsing, software installation and hack attacks that exploit system vulnerabilities. Many of these approaches at some point attempt to gain access to the file system, either to engage their malicious payload or to invade privacy and compromise system integrity and confidentiality.

Typically a set of key applications are at risk from malicious exploits. These include for example network facing operating system services, web facing applications, such as internet explorer, and email applications.

Once malware has exploited a vulnerability, in many instances it is possible that it might wish to persist by saving itself to permanent storage system via the file system. The malware may also wish to take control of key operating system files or to perform operations that depend on access to system files and utilities (e.g. cmd.exe in the context of the Microsoft™ Windows™ operating systems).

An antivirus scanner, such as antivirus software, checks files and email messages, looking for matches to known attack signatures. However, the use of a library of known attack signatures means that a new virus having an unknown attack signature will not be detected by the antivirus scanner, at least until a corresponding new signature is added to the library used by the scanner.

A firewall, which may be implemented in hardware or software or a combination, generally monitors requests to open a port of a network router or the like where the request is from outside the network. The router blocks access to a port when a request to access a particular port is not expected or allowed in accordance with a set of rules. However, hackers often use legitimate access to a port in order to “smuggle” in a trojan or the like, and thus such attacks are not prevented by a firewall.

### 3. SUMMARY OF INVENTION

According to a first aspect of the present invention, there is provided a method of host intrusion prevention for preventing intrusion into a computer system, the method comprising: monitoring requests to access a resource of the computer system; determining whether the requested access is to be permitted or not in accordance with a policy; and, allowing or denying the requested access accordingly.

The preferred embodiments of the present invention prevent infection of computer applications and operating system programs through the use of malicious software and operates outside of (i.e. in addition to) the protection that is applied intrinsically by the computer operating system itself. The preferred embodiments of the present invention have particular application in providing a file system control mechanism to prevent system intrusion on computer systems running Microsoft™ Windows™ operating systems. Nevertheless, the present application has application in the context of other operating systems, including Unix, Solaris, Linux, etc.

In an embodiment, the monitoring of requests is carried out by intercepting all calls to a file system of the computer system and interpreting the desired access to the target object of said calls, the determining being carried out in accordance with a policy for the target objects. This provides a method for locking file access in a fine granular manner so that processes attempting to access file system objects can be limited in definable ways.

The policy is preferably stored in the form of metalanguage definitions. Most conveniently, the metalanguage is XML. The use of XML in the present has a number of advantages, including the fact that the policy definitions are easily read, understood, written and amended by a human operator, and is thus useful in the present context both for software developers and end users.

In an embodiment, the policy determines access rights for plural computer processes, the plural computer processes being grouped such that at least one of said computer processes is considered a parent process and another of said computer processes is considered a child of said parent process, the policy containing inheritance rules that determine the policy for said child process at least partly in dependence on the policy for said parent process. This allows for economy in the policy definitions. This is particularly straightforward to implement where XML is used as the language structure for the policy definitions.

In an embodiment, if the requested access is a request to open a file object and the policy determines that said file object may be opened, then the requested access is permitted to open said file object and the requested access is denied only at the time the requested access attempts a write operation and the policy determines that the write operation is not permitted. This technique is referred to generally herein as “deferred write” and reduces the risk of false positives caused by applications that open files with full access but do not actually need to write to the file object.

In another aspect, the present invention relates to a computer program comprising program instructions for causing a computer to carry out a method as described above.

In another aspect, the present invention relates to a storage medium having stored thereon a computer program as described above.

In another aspect, the present invention relates to a computer programmed to carry out a method as described above.

The preferred embodiment has at its core a file system “filter driver”. This filter driver intercepts all calls to the file system and interprets the target object and matches this against a set of policy rules. The policy defines the fine grained access allowed to be determined and configured on any security access permission bit. Policies are defined based on the required access of an image or processes. Processes are defined as the short executable name of the executable and/or they may be further qualified by the full path name of the image. Once the images or processes have been defined, the access that is allowed or disallowed for specific file objects is defined. This is done by defining a single or group of files to be “locked” in a specific manner depending on the specified permissions.

### 4. BRIEF DESCRIPTION OF DRAWINGS

Embodiments of the present invention will now be described by way of example with reference to the accompanying drawings, in which:

FIG. 1 shows schematically the overall process flow of an example of a method in accordance with an embodiment of the present invention;

FIG. 2 shows schematically a process flow for an example of file permission processing in accordance with an embodiment of the present invention; and,

FIG. 3 shows schematically a process flow for an example of write check processing in accordance with an embodiment of the present invention.

### 5. DESCRIPTION

Briefly, in a preferred embodiment, as an initial step, after the host intrusion prevention software has been installed on a computer, an interface device driver (hereinafter the “filter driver”) is inserted into the file system of the computer during boot up of the operating system. This filter driver allows all requests to the file system to be intercepted and examined. Each time a file system driver registers itself with the operating system, information about the incoming file system is passed to the filter driver. This allows the filter driver to control access by the file system to system resources, such as hard disk or other non-volatile storage, dynamic libraries, configuration data, etc., in accordance with policy definitions.

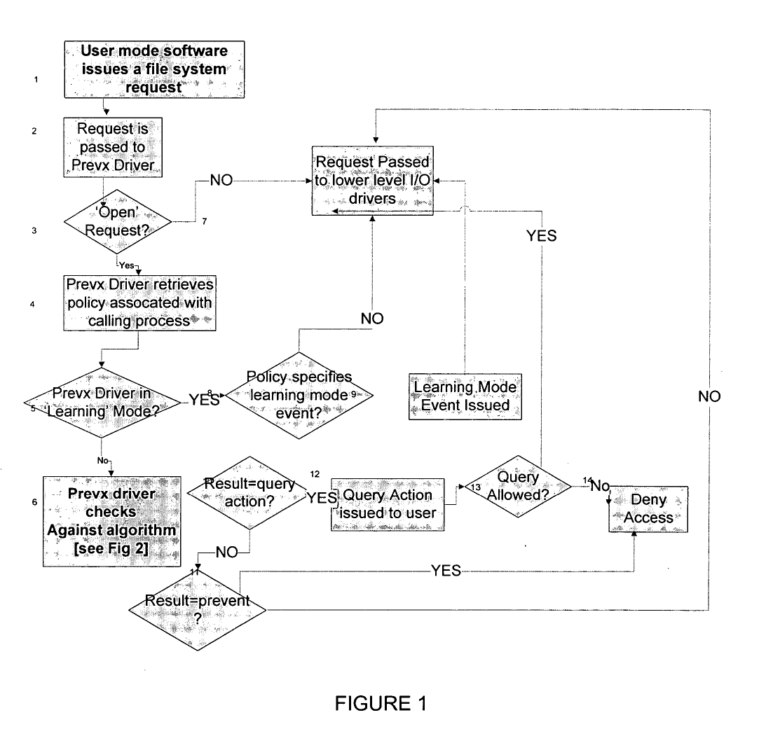

Referring to FIG. 1, the overall process flow of an example of a method in accordance with an embodiment of the present invention is as follows:

1. User mode software issues a file system request.

2. The request reaches the filter driver.

3. If the request is not an open operation, it is passed to the underlying driver.

4. If the request is an open operation, the filter driver continues checking.

5. The filter driver retrieves the policy associated with the calling process. Process-policy associations are formed during a policy application phase.

6. If the filter driver is in LearningMode and the policy specifies learning mode for file system events, an appropriate LearningMode event is issued and the request is passed to the underlying driver.

7. If the filter driver is not in LearningMode, then the filter driver continues checking.

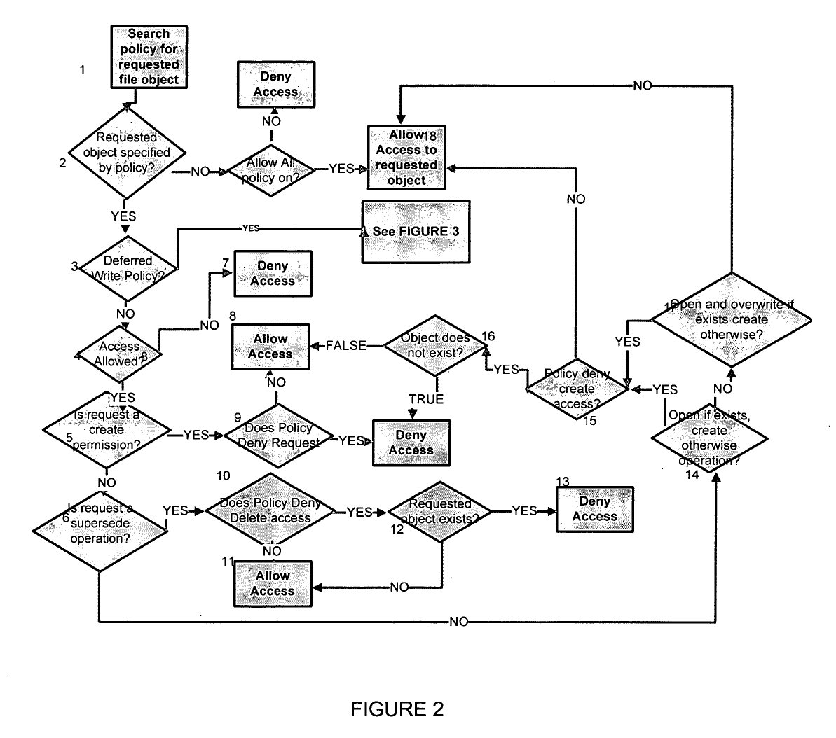

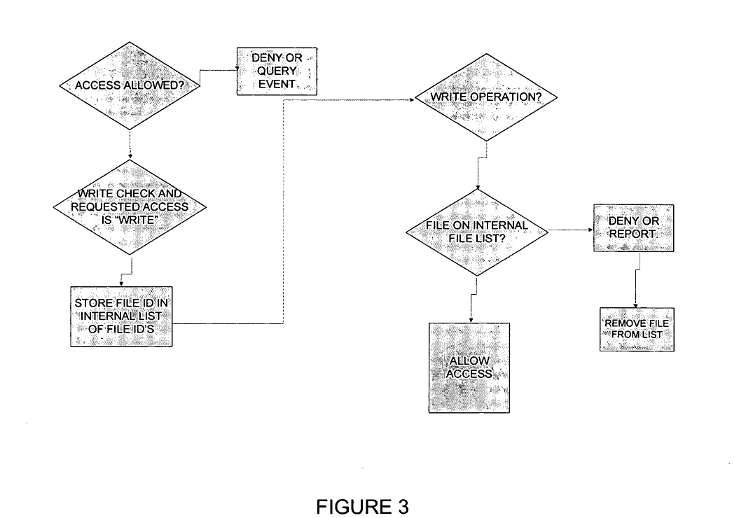

8. The filter driver checks requested permissions against the specified policy. File system permission checking is discussed in more detail below with reference to FIGS. 2 and 3.

9. If the permission check resulted in a query action, then the user is queried for the desired action.

10. If the permission check resulted in a report action, then the software implementing the filter driver is notified.

11. If the permission check resulted in deny action (or the user selected to deny the request when the user was queried), the software implementing the filter driver is notified and the file system request is denied.

In detail in the context of Microsoft Windows operating systems in particular, during boot up the filter driver registers a file system register notification change via the IoRegisterFsRegistrationChange( ) operating system API (application programming interface). Each time a file system driver registers itself with the operating system, the callback function is invoked, thus passing information about the incoming file system to the filter driver. This allows the filter driver to create a device attached to the file system (or file systems) and attached to the incoming file system control device object. Attaching a device to the stack of devices on the file system control device allows I/O (input/output) control operations directed to the file system control device via IRP_MJ_FILE_SYSTEM_CONTROL IOCTL to be seen. This then allows IRP_MN MOUNT_VOLUME to be trapped. Trapping IRP_MN_MOUNT_VOLUME in turn allows the filter driver to attach to the volume devices created by the file system, thus allowing the filter driver to trap all I/O operations to the files contained within the volume.

Trapping I/O directed to the volume devices, and altering the normal behaviour based on input from the policy engine, which implements policy definitions, is an important aspect of the preferred embodiment. Trapped IOCTL codes for volume devices are managed via the IRP_MJ_CREATE operation which is handled and processed by the filter driver. In this regard, the preferred filter driver operates as follows:

1. An attempt is made to open a protected file by user mode code.

2. Eventually, a file is opened or created by the subsystem in which it originated, typically resulting in a call to the NtCreateFile( ) system service.

3. Calling NtCreateFile( ) from user mode will cause a ring transition, i.e. a user mode to kernel mode escalation, and control is passed to the kernel mode system call handler.

4. The system call relies on the I/O manager to perform the requested operation. A specially created IRP (I/O Request Packet) is created by the I/O manager, the target device is identified by name, and the IRP is sent down the device stack.

5. Because the filter device driver is layered on the file system stack, its IRP_MJ CREATE handler will be called. The filter driver is therefore given the opportunity to examine the request and respond in accordance with the currently loaded policy.

Trapping I/O directed to the network file system is also an important aspect of the preferred embodiment and is achieved by filtering requests to the file system control device but not to the volume device. The request is identified by device type which is FILE_DEVICE_NETWORK_FILE_SYSTEM.

The filter driver creates a variety of devices, for example the main device object, device objects that are layered on the file system control stack, and device objects that are layered on the volume device stack. Since the IRP handling entry points are global, the filter driver carefully identifies the type of device on which the I/O request is directed and acts accordingly depending on the policies in force.

In summary, an example of the boot and load sequence for the filter driver is as follows:

1. On operating system boot, the filter driver subscribes to file system register/unregister activity notifications (via the IoRegisterFsRegistrationChange function).

2. File system drivers that are loaded after the filter driver has been loaded register with the operating system (using the IoRegisterFileSystem function). Preferably therefore the filter driver loads before all file system drivers.

3. The filter driver receives notification about file system registrations and attaches itself to the file system devices (using the IoAttachDeviceToDeviceStack or IoAttachDeviceToDeviceStackSafe function).

4. Volume requests addressed to file system drivers are first received by the filter driver, which waits for the completion of the mount request and then attaches itself to the file system driver that has just mounted.

5. All file system requests are filtered by the filter driver.

It should be noted that some file system drivers may not or do not register themselves with the operating system as a file system driver. For example, in Windows NT the LanmanRedirector is a system-supplied network file system driver that provides access to files on remote machines and does not register itself in the operating system as a file system driver (it does not call IoRegisterFileSystem). To attach to this or similar devices that do not register themselves with the operating system, the filter driver queries LanmanRedirector or other similar devices for existence periodically, for example each second. As soon as LanmanRedirector or another similar device starts working in the operating system, the filter driver attaches to it and stops queries for existence of that device.

In the preferred embodiment, the processing logic and rules are defined by a set of XML policy definitions that are parsed by a policy engine before being sent to the filter driver. The policies or rules are then held in the filter driver's kernel memory region and are used in deciding actions depending on file access attempts of any nature. When a file system access policy rule is compromised, a message is sent from kernel mode to user mode together with information indicating the policy that was violated, the objects involved, and the access attempts.

XML stands for extensible Markup Language. XML is a system for defining, validating, and sharing document formats. XML is a “metalanguage”, i.e. a language for describing other languages. In general, XML uses tags to distinguish document structures, and attributes to encode extra document information. The XML format has the particular advantages that the policy definitions are easily read, understood, written and amended by a human operator, and is thus useful in the present context both for software developers and end users.

Below is an example of the syntax of the rules which will dictate and control the actions taken by the filter driver.

```
    <policy ID=“1” inherit=“include”>
        <process>
            <name>cmd.exe</name>
            <name>foo.exe</name>
        </process>
        <image>
            <path> C:\WINNT\System32\cmd.exe
</path>
            <path> D:\...\cmd.exe </path>
    <excludedPath>
C:\Program Files\Office\WinWord.exe </excludedPath>
        </image>
        <FSC writecheck=“yes”>
            <lockedpath>c:\somedir\...\
                <permissions>
                    <traverse/>
                    <delete/>
                    <read/>
                    <write check=“yes”/>
                    <execute/>
                    <DAC/>
                    <owner/>
                <accessSystemSecurity/>
                <create/>
            </permissions>
        </lockedpath>
    </FSC>
```

Here “FSC” in an abbreviation for the term file system control. The syntax for each tag defining the file system control protection is as follows:

The <policy> tag defines a set of protection features to be applied to process or, more generally, a group of processes. <policy> has two attributes:

| # | Name | Type | Description |
|---|---|---|---|
| 1 | ID | Number, | Unique policy identifier |
| | | mandatory | |
| 2 | inherit | String, | Specifies the rules of |
| | | optional | policy inheritance. |
| | | | Possible values are |
| | | | “include” (default), “none”, |
| | | | “exclude” and “all”. This |
| | | | defines the inheritance |
| | | | behaviour for child |
| | | | processes. |

The Policy ID must be larger or equal then 1. Policies with negative or zero IDs are reserved for special purposes.

There are rules for policy inheritance as follows:

(i) none: child process do not inherit parent policies.

(ii) all: child process inherit policies applied to the parent and policies from which the parent process are excluded.

(iii) include: only policies applied to the parent process are inherited.

(iv) exclude: only policies that the parent process excludes are inherited.

By way of example:

```
<policygroup>
        <policy ID=“1” inherit=“exclude”>
            ...
        </policy>
        <policy ID=“2” inherit=“none”>
            ...
        </policy>
    <policy ID=“3” inherit=“all”>
            ...
        </policy>
        <policy ID=“4” inherit=“include”>
            ...
        </policy>
            ...
</policygroup>
```

The <process> tag is a placeholder for <name> tags representing the name of the or each process.

By way of example:

<process>
...
</process>

The <name> tag defines the executable image short name. Content syntax for the tag is:
{string}.

Monitoring is applied to all processes that have process names defined within <name> tags. Multiple <name> tags are allowed within <process> tag. An empty <name> tag is not allowed.

By way of example:

<process>
<name>cmd.exe</name>
</process>

The <image> tag is a placeholder for <path> tags representing the location for the or each process image, and has child tags of the form <path> and <excludedPath>.

By way of example:

<image>
...
</image>

The <path> tag defines the full file system path and name for the executable image. Content syntax for the tag is:
{file path}

Monitoring is applied to all processes created from this image and to all processes defined in the <name> tag. Network paths can be used within the <path> tag. For example, if a path's first two symbols are “\\”, it is interpreted as a network path. Multiple <path> tags are allowed within an <image> tag. An empty <path> tag is not allowed.

By way of example:

```
    <image>
        <path>C:\Program Files\...\foo.exe</path>
        <path>C:\Program Files\Half-
Life\hl.exe</path>
        <path>C:\Program Files\ICQ\*.exe</path>
    </image>
```

The <FSC> tag defines a set of file access rights for the processes defined within the policy. Controlled processes are able to access any file system objects that are not listed in this tag (which is the preferred default behaviour). The <FSC> tag has three attributes:

| # | Name | Type | Description |
|---|---|---|---|
| 1 | disable | “yes”/“no” | “no” or absence of this |
| | | | attribute enables FSC |
| | | | protection for the given |
| | | | group of processes; |
| | | | “yes” disables FSC protection |
| | | | for the given group of |
| | | | processes (i.e. these |
| | | | processes have unrestricted |
| | | | access to files and |
| | | | directories). |
| | | optional | |
| 2 | default | “AllowAll” | By Default is “DenyAll”. |
| | | | This attribute is used to |
| | | | change default to “AllowAll”. |
| | | optional | |
| 3 | onAlert | “reportOnly”/ | By default is “denyAccess”. |
| | | “denyAccess”/ | This attribute is used to |
| | | ”query” | change default to |
| | | | “reportOnly”. |
| | | optional | |
| 4 | writecheck | “yes”/“no” | “yes” stands for write |
| | | | requests should be filtered |
| | | | (open operation should not be |
| | | | affected). |
| | | optional | “no” is the default value. |

If there is no <FSC> tag, then <FSC disable=“yes”> is assumed. An empty <FSC> tag denotes that no access to files/directories for the processes is defined within the policy. Child tags for the <FSC> tag include <lockedpath>.

By way of example:

```
    <FSC disabled=“no” default=“AllowAll”
onAlert=“reportOnly”>
    ...
    </FSC>
    <FSC default=“DenyAll” writecheck=“yes”>
      ...
    </FSC>
```

The <excludedpath> tag defines the full file system path and name for the or each executable image to be excluded from the policy. Content syntax for the tag is
{file path}

Monitoring is not applied to all processes created from this image. Network paths can be used within <path> tag. If a path's first two symbols are “\\”, it is interpreted as a network path. Multiple <excludedpath> tags are allowed within the <image> tag. An empty <excludedpath> tag is not allowed.

By way of example:

```
    <image>
        <excludedPath>C:\Program
Files\...\foo.exe</excludedPath>
    </image>
```

The <lockedpath> tag defines a file system object (directory or file) or a set of files and their access rights for the processes defined within the policy. Content syntax for the tag is:
{file path}

Multiple <lockedpath> tags can be provided within <FSC>.

The path value in the <lockedpath> tag ending with “\” defines the directory. Any other symbol means file(s) only. A child tag is:

```
    <permissions>
By way of example:
    <lockedpath>C:\
        <permissions>
            <create/>
            <execute/>
            <read/>
            <write/>
        </permissions>
    </lockedpath>
    <lockedpath>D:\*.dll</lockedpath>
```

The <permissions> tag is a placeholder for tags that defines permissions for the files pointed to in <lockedpath>. Permissions that can be protected by the preferred embodiment are as follows:
<traverse> For a directory, the right to traverse the directory.
<delete> Delete file or directory.
<read> For a file object, the right to read the corresponding file data. For a directory object, the right to read the corresponding directory data (i.e. list the directory).
<write> For a file object, the right to write data to the file. For a directory object, the right to create a file in the directory.
<execute> The right to execute the file. Ignored for the directories.
<DAC> The right to modify the DACL (discretionary access control list) in the object's security descriptor (for file and directories).
<owner> The right to change the owner in the object's security descriptor (file and directories).
<accessSystemSecurity> The right to manage the SACL (system access control list) in an object's security descriptor (files and directories).
<create> For a directory or file object, the right to create a file or directory

The <write> tag has an attribute check as follows:

Check: “yes” stands for write requests should be filtered (open operation should not be affected).

“no” should be the default value.

By way of example:

```
<policygroup>
    <policy ID=“1”>
    ...
        <FSC>
            <lockedpath>C:\tmp\*.doc
                <permissions>
                    ...
                    <write check=“yes”/>
                </permissions>
            </lockedpath>
        </FSC>
    <policy>
...
</policygroup>
```

In the preferred embodiment, two modes of operation with regard to access write checks are available.

One mode is represented by normal open operations, that is, the permissions with which a program accesses an object at the time of the open request. In some situations this approach offers protection that is less than optimal because often file objects are opened with all permissions, even though only lesser permissions are required for the particular operation. At this point the filter driver acts as if a write operation were attempted, even though this would not necessarily be the case.

The second mode of operation is termed herein “deferred write”. In this mode, the check is not performed until the actual time of the I/O operation. This allows protection checks to be performed at the times of operation rather than at the time of opening access to an object. This approach reduces the risk of false positives caused by applications that open files with full access but do not actually need to write to the file object.

In detail, the filter driver filters

IRP_MJ_WRITE and IRP_MJ_FLUSH_BUFFERS requests as well as FastIoWrite( ), PrepareMdlWrite( ) and FastIoWriteCompressed( ) fast I/O calls. When a process issues a write operation for a file object, the driver looks up the open files table for this file object. If the file object is in the table, then the operation is filtered. If the file object is not found in the table, then the write operation is allowed.

If the operation is filtered and should be denied, then a report event is sent if the write operation is the first for the given file object. In any event, the request is completed immediately with STATUS_ACCESS_DENIED status.

If the operation is filtered and a user is queried, the request is processed depending upon the user decision. If the user denies the write operation, then the file object is marked as denied for write and all subsequent write operations will be denied without query. If the user allows the write operation to be performed, then the file object is removed from the open files table and the operation is allowed.

If the operation is filtered and the operation should be reported, then a report event is sent. The file object is also removed from the open files table. The operation is then allowed.

Referring now to FIG. 2, the preferred algorithm used to determine whether or not file access is granted is as follows.

On file system request, the filter driver performs the following actions:

1. Search a policy for the requested file object.

2. If the requested object is not specified by the policy:
2.1. allow request if the policy is allowAll; or
2.2. deny request if the policy is denyAll.

3. If the requested object is specified by the policy, check whether the deferred write mode of operation is in force. If yes, then proceed to deferred write checking (discussed further below with reference to FIG. 3), else continue:

4. Check the object access right (except create access rights).

5. If the requested access is allowed, check create permissions:
5.1. if request is a create operation and the policy denies create access, then deny the request;
5.2 if request is a supersede operation (replace if exists, create otherwise), and the policy denies delete access, and the requested object already exists, then deny the request;
5.3. if request is an “open if exists, create otherwise” or “open and overwrite if exists, create otherwise” operation, and the policy denies create access, and the requested object does not exist, then deny the request;
5.4 allow request otherwise.

Referring to FIG. 3, where the deferred write mode of operation is in force, the preferred algorithm for checking of deferred writes is as follows:

1. File request is an open operation.
1.1. Check requested permissions (as earlier).
1.2. If the requested access is denied, deny the file request.
1.3. If the requested access is allowed, continue file request handling.
1.3.1. Send the file request to the lower-level file system driver.
1.3.2. If the policy specifies to check write operations and requested permission set contains write permission, store the corresponding file object in the internal table of opened files with additional information about write operation actions, such as:
1.3.2.1. User should be queried on first write operation.
1.3.2.2. Any write operation should be denied, first one should be reported.
1.3.2.3. First write operation should be reported.

2. File request is a write operation.
2.1. If the requested file object is not in the internal table of opened files, send the file request to lower-level file system driver.
2.2. The requested file object is in the internal table of opened files, continue permission checking.
2.2.1. If the operation should be denied:
2.2.1.1. A report event is sent if the write operation is the first for the given file object.
2.2.1.2. The request is completed immediately with STATUS_ACCESS_DENIED status.
2.2.2. If a user is queried the request is processed depending upon the user decision:
2.2.2.1. If the user denies the write operation, then the file object is marked as denied for write and all subsequent write operations will be denied without query.
2.2.2.2. If the user allows the write operation to be performed, then the file object is removed from the open files table and the operation is allowed.
2.2.3. If the operation should be reported:
2.2.3.1. A report event is sent.
2.2.3.2. The file object is removed from open files table.
2.2.4. The operation is allowed.

Embodiments of the present invention have been described with particular reference to the examples illustrated. However, it will be appreciated that variations and modifications may be made to the examples described within the scope of the present invention.

1. A method of host intrusion prevention for preventing intrusion into a computer system, the method comprising:
monitoring requests to access a resource of the computer system;
determining whether the requested access is to be permitted or not in accordance with a policy; and,
allowing or denying the requested access accordingly.

2. A method according to claim 1, wherein the monitoring of requests is carried out by intercepting all calls to a file system of the computer system and interpreting the desired access to the target object of said calls, the determining being carried out in accordance with a policy for the target objects.

3. A method according to claim 1, wherein the policy is stored in the form of metalanguage definitions.

4. A method according to claim 3, wherein the metalanguage is XML.

5. A method according to claim 1, wherein the policy determines access rights for plural computer processes, the plural computer processes being grouped such that at least one of said computer processes is considered a parent process and another of said computer processes is considered a child of said parent process, the policy containing inheritance rules that determine the policy for said child process at least partly in dependence on the policy for said parent process.

6. A method according to claim 2, wherein the policy determines access rights for plural computer processes, the plural computer processes being grouped such that at least one of said computer processes is considered a parent process and another of said computer processes is considered a child of said parent process, the policy containing inheritance rules that determine the policy for said child process at least partly in dependence on the policy for said parent process.

7. A method according to claim 1, wherein if the requested access is a request to open a file object and the policy determines that said file object may be opened, then the requested access is permitted to open said file object and the requested access is denied only at the time the requested access attempts a write operation and the policy determines that the write operation is not permitted.

8. A method according to claim 2, wherein if the requested access is a request to open a file object and the policy determines that said file object may be opened, then the requested access is permitted to open said file object and the requested access is denied only at the time the requested access attempts a write operation and the policy determines that the write operation is not permitted.

9. A method according to claim 5, wherein if the requested access is a request to open a file object and the policy determines that said file object may be opened, then the requested access is permitted to open said file object and the requested access is denied only at the time the requested access attempts a write operation and the policy determines that the write operation is not permitted.

10. A method according to claim 6, wherein if the requested access is a request to open a file object and the policy determines that said file object may be opened, then the requested access is permitted to open said file object and the requested access is denied only at the time the requested access attempts a write operation and the policy determines that the write operation is not permitted.

11. A computer program comprising program instructions for causing a computer to carry out a method according to claim 1.

12. A storage medium having stored thereon a computer program according to claim 11.

13. A computer programmed to carry out a method according to claim 1.
